(19) United States
(12) Patent Application Publication
(10) Pub. No.: US 2002/0108965 A1
(43) Pub. Date: Aug. 15, 2002

(54) Fluid delivery device

(75) Inventors: Peter J. Hill, Newtown, CT (US); Paul J. Carrubba, Baldwin, NY (US); Vito James Carlucci, Stratford, CT (US); John Edward Gogol JR., Trumbull, CT (US); Harold Roy Taylor, Stratford, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CIP, INC.

(21) Appl. No.: 09/998,015

(22) Filed: Nov. 30, 2001

Related U.S. Application Data
(60) Provisional application No. 60/250,903, filed on Dec. 2, 2000.

(51) Int. Cl. B67B 7/00

(52) U.S. Cl. 222/54; 222/1

(57) ABSTRACT

A fluid heating and dispensing device and method of using the device, is provided. The device has a first reservoir, a second reservoir, a pump device, a heating device, and a delivery device. The first reservoir is in thermal communication with the heating device, the second reservoir is in substantial thermal isolation from the heating device, the first reservoir is substantially smaller than the second reservoir and the pump device selectively causes fluid to flow between the reservoirs and to the atmosphere. The device can have a removable supply container for refilling.

### RELATED APPLICATION

This application is related to and claims priority in, copending U.S. Provisional Application Ser. No. 60/250,903, filed Dec. 2, 2000, the disclosures of which are incorporated herein by reference.

### BACKGROUND OF THE INVENTION

1. Field of the Invention

The present invention relates to an apparatus or device that warms or heats lotion. More particularly, the present invention relates to an apparatus that warms or heats and dispenses, either manually or electrically, a warmed lotion, such as, but not limited to, a hand or body lotion.

2. Description of the Prior Art

There are devices that are commercially available that dispense liquids, such as lotions. There are devices commercially available that heat fluids. There are also devices commercially available that heat and dispense fluids from containers having a propellant. However, heretofore, there has been a need for a device that efficiently warms and dispenses a lotion, such as a hand or body lotion, from a container.

### DESCRIPTION OF THE FIGURES

FIG. 1 is a perspective view of a warmer and dispenser device of the present invention;

FIG. 2 is a cross-sectional view of a first embodiment of the device of FIG. 1 taken along line 2-2 of FIG. 1;

FIG. 3 is a plan view of the removable container of the device of FIG. 1;

FIG. 4 is a cross-sectional view of the container of FIG. 3 taken along line 4-4 of FIG. 3;

FIG. 5 is a plan view of the container top of the device of FIG. 1;

FIG. 6 is a cross-sectional view of a second embodiment of the device of FIG. 1 taken along line 2-2 of FIG. 1;

FIG. 7 is a perspective view of an alternative warming system of the device of FIG. 1;

FIG. 8 is a perspective view of an alternative warming system of the device of FIG. 1;

FIG. 9 is a perspective view of an alternative warming system of the device of FIG. 1;

FIG. 10 is a perspective view of an alternative warming system of the device of FIG. 1; and

FIG. 11 is a flow chart depicting a method for warming and dispensing lotion according to the device of FIG. 1.

### SUMMARY OF THE INVENTION

It is an object of the present invention to provide a fluid warmer and dispenser device.

It is another object of the present invention to provide such a device that warms and/or heats lotions, such as hand and body lotions.

It is yet another object of the present invention to provide such a device that dispenses the lotion by a pump.

It is a further object of the present invention to provide such a device that simplifies the lotion filling process.

It is yet a further object of the present invention to provide such a device with a more efficient heating process.

These and other objects and advantages of the present invention are achieved by the lotion warmer and dispenser or system of the present invention (hereinafter “warmer”) that provides a lotion to the user at a desired temperature. The warmer includes a delivery system, a supply or reservoir, and a warming or warmer system. Preferably, the delivery system, supply, and warming system form an assembled unit.

In a preferred embodiment, the warmer of the present inventions heats only a small amount of the lotion in the aluminum tube in line between the output and the lotion supply. Since the warmer does not have to provide heat to the entire reservoir of the lotion, a rapid heat up time is provided. Additionally, it is important that the lotion not be overheated as the formula of most lotions will degrade and/or separate when overheated. The temperature controller of the present invention also allows for almost no temperature overshoot, further reducing the likelihood of degrading the lotion. Moreover, the present invention isolates the electrical components, thus reducing the likelihood of injury if the warmer is accidentally exposed to wet conditions.

### DESCRIPTION OF THE INVENTION

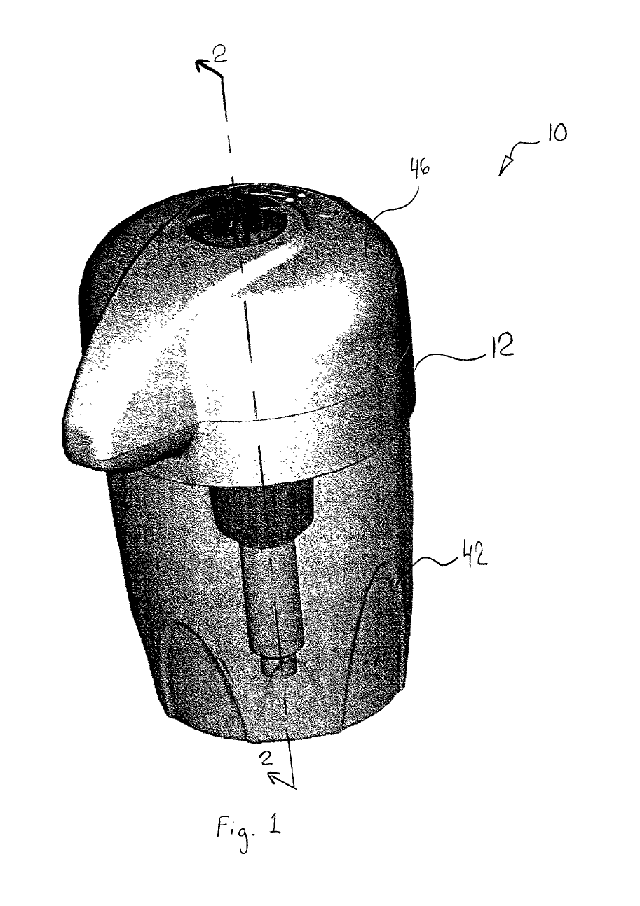

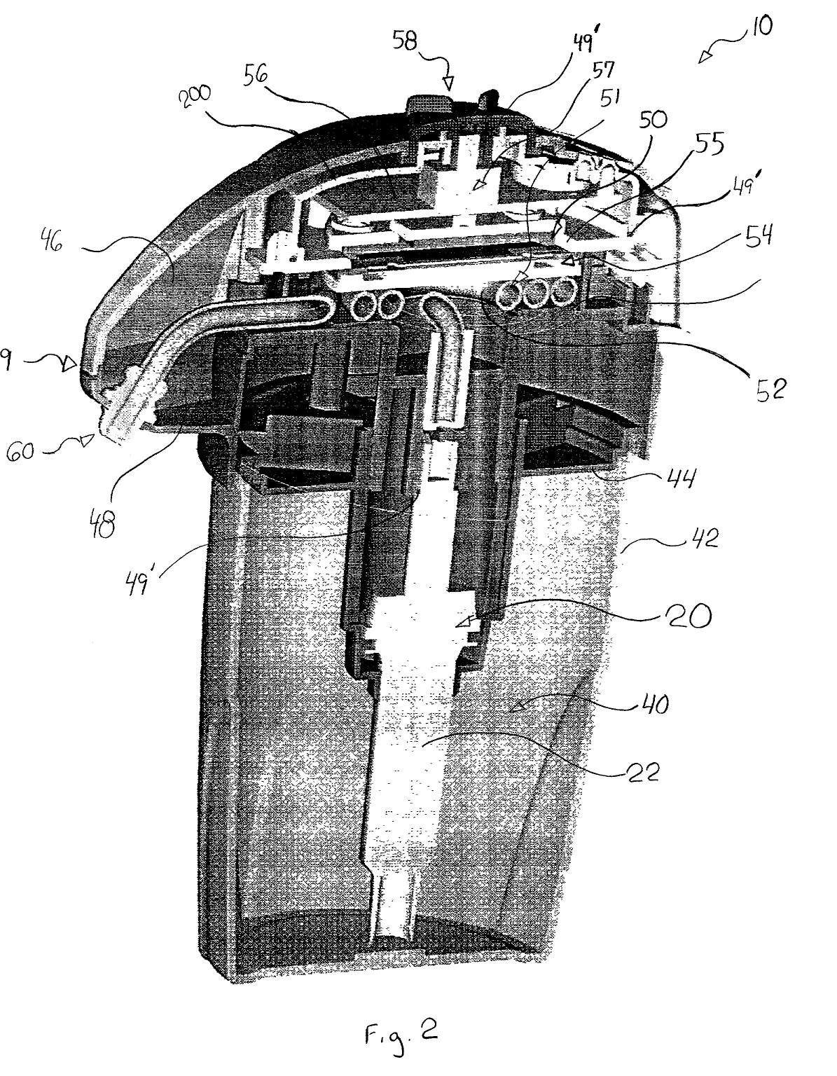

Referring to the figures and particularly to FIGS. 1 and 2, there is provided a system or warmer generally designated by reference numeral 10 is shown. Warmer 10 has a delivery system 20, a supply or reservoir 40, and a warming or warmer system 50. Preferably, delivery system 20, supply 40, and warming system 50 form an assembled unit 12.

Warmer 10 dispenses lotion at a desired temperature. The desired temperature is preferably in a range from about 30° to about 60° C. More preferably, the desired temperature is about 45° C. Warmer 10 also has a mechanism to allow the consumer to turn on or shut off power to the warmer. In a preferred embodiment, warmer 10 automatically shuts off after it has been “on” for about 1 hour.

As shown in FIG. 2, delivery system 20 has a pump mechanism, such as, for example, a manual pump 22. The pump 22 delivers lotion from supply 40 to lotion warming system 50 and, then, to the user via an output section 60. In the preferred embodiment, output section 60 is a downwardly directed spout. A power cord (not shown) delivers power from a standard household electrical supply to warmer 10. Alternatively, warmer 10 has a battery (not shown) that delivers power to the warmer. The pumping mechanism is either manual (as in the preferred embodiment) or electric.

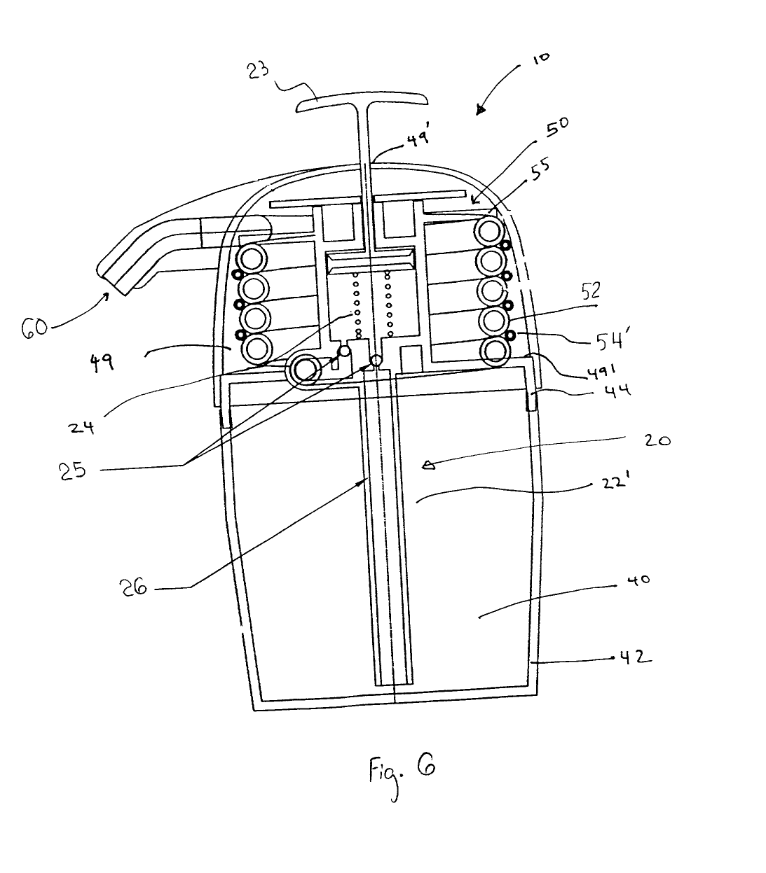

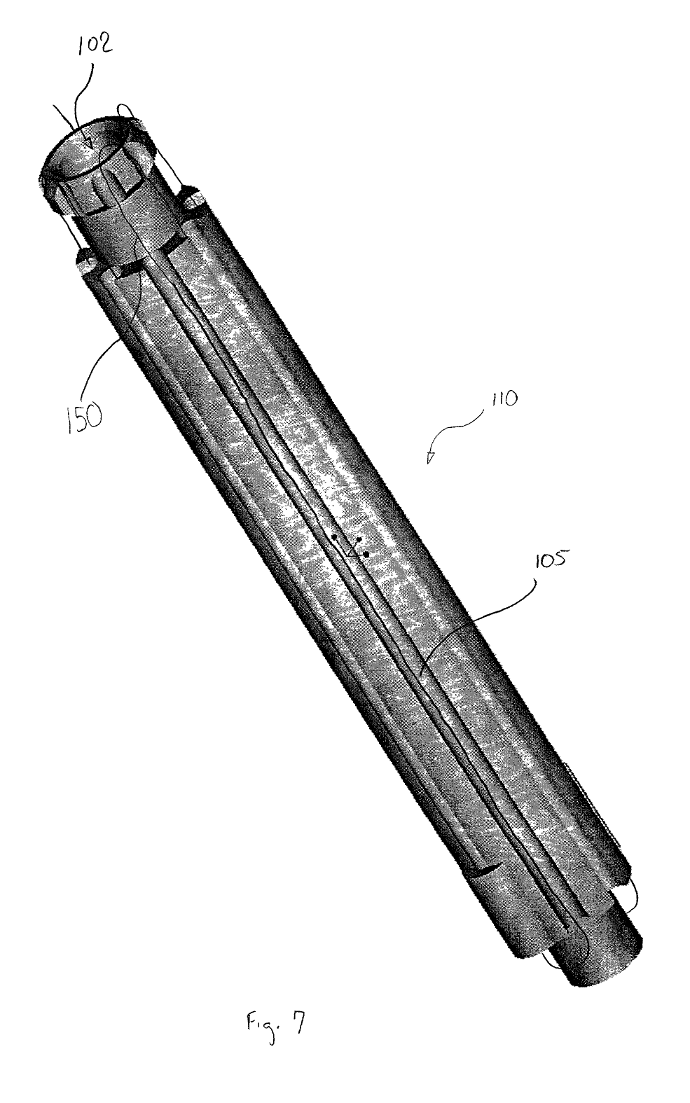

Referring to FIGS. 2 through 5, supply 40 has a container 42 for holding lotion. Preferably, container 42 is refillable. More preferably, container 42 has a removable container top 44. By way of example, container 42 holds between about 2 to about 20 fluid ounces of lotion, and preferably between about 6 to about 16 fluid ounces of lotion. Top 44 removably seals container 42. Container 42 and top 44 are preferably made of dishwasher safe material, such as plastic, aluminum, metal or any combination thereof.

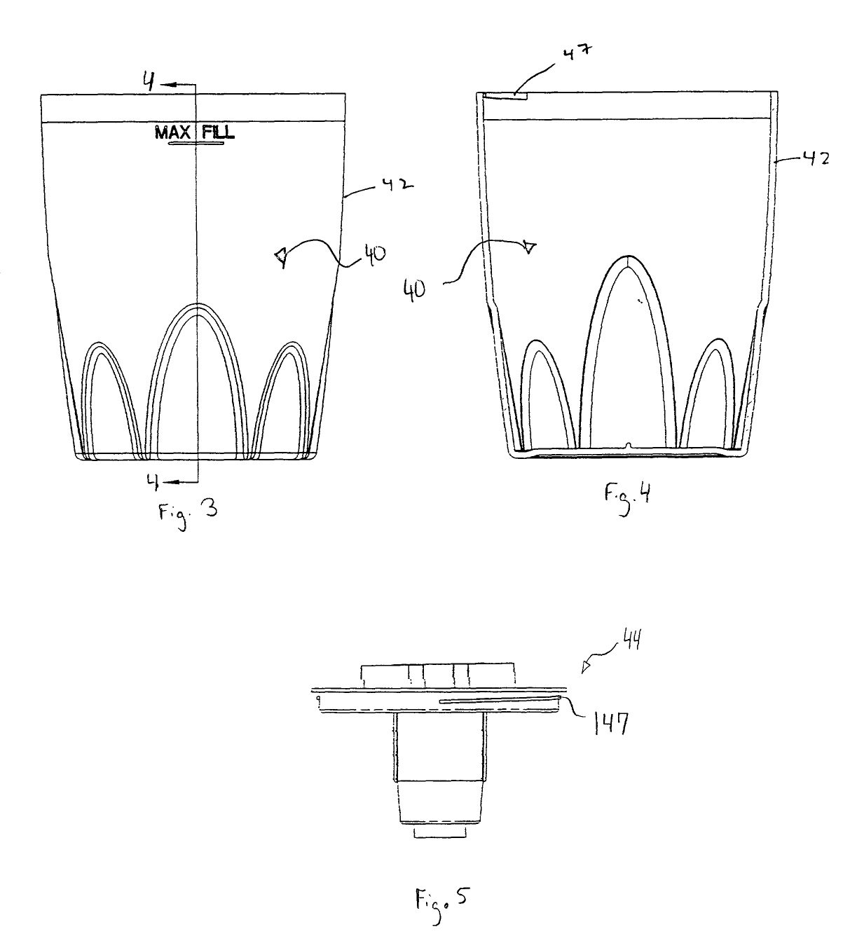

Referring to FIGS. 3 through 5, assembly 49 (by way of top 44) is adapted to be connected to container 42. Preferably, top 44 is adapted to be connected to container 42 by a connector 47. In a preferred embodiment, connector 47 of container 42 engages with tab 147 of container top 44. This allows a quick connection that requires the user to only rotate container 42 not more than 180 degrees with respect to enclosed assembly 49. The removability of container 42 is a further advantage of the present invention since it allows for easy refilling of warmer 10.

Referring to FIGS. 1 and 2, warmer 10 also has an upper lid 46 and a lower lid 48. Upper lid 46 and lower lid 48 are joined to form enclosed assembly 49. Assembly 49 also has one or more seals 49′, preferably two or more seals 49′, that ensure that enclosed assembly 49 is water tight to prevent injury in the event warmer 10 is exposed to wet conditions.

Warming system 50 has a heat transfer section 51 and a temperature controller 57. Heat transfer section 51 has a coil of tubing 52 and a resistance heater 54. Tubing 52 can be made of aluminum, metal, or plastic that withstands high temperatures. Preferably, tubing 52 is made of aluminum. As shown in FIG. 2, tubing 52 has a flat coil configuration. Preferably, tubing 52 is wound a number of times, preferably about five times.

Resistance heater 54 is preferably flat. Heater 54 preferably is made of mica. In this embodiment, heater 54 has a heater cover 55. Cover 55 directs heat from heater 54 towards tubing 52, thus heating the fluid in the tubing. Further, cover 55 directs heat away from controller 57 which is described below in more detail. Thus, controller 57 is substantially in thermal isolation from heater 54. Also, the one or more seals 49′ cause controller 57 to be in fluid isolation from tubing 52 and supply 40.

Resistance heater 54 is connected to, or part of, heat transfer section 51 in a manner that maximizes the surface contact between the resistance heater and the heat transfer section. In a preferred embodiment, heater 54 is connected to tubing 52 and enclosed by cover 55 to maximize the surface contact between the heater and the tubing and thereby reduce heat loss. Accordingly, warmer 10 maximizes the heat conducted from heater 54 to tubing 52 and ensures a rapid heat up cycle. Further, the volume of tubing 52 is substantially smaller than the volume of container 42. Typically, warmer 10 provides lotion at the desired temperature in about 1 to about 2 minutes.

Warming system 50 also has a temperature controller 57. Controller 57 controls the temperature of lotion warming system 50 so as to provide a rapid heat up cycle, yet avoid overshoot of the desired temperature. Controller 57 is preferably connected to heater 54. For embodiments using an electric pump, controller 57 is connected to pump 22. In a preferred embodiment, controller 57 is an NTC controller having a printed circuit board 56 (hereinafter “PCB”) operatively connected to two or more controls 58 (described in detail below). Controller 57 is commonly used in electric curling irons and the like. Alternative control devices can also be utilized such as a thermostat.

Controller 57 has a controller housing 200 sealingly engaged with heater cover 55 through seals 49′. This sealing engagement further ensures that controller 57 and all electrical components (or other control devices such as a thermostat) contained therein, are substantially thermally isolated from heater 54, and in fluid isolation from supply 40 and tubing 52.

Preferably, controller 57 controls the temperature of heater 54 to the desired temperature in a range from about 30° to about 60° C. More preferably, controller 57 controls the temperature of heater 54 to the desired temperature of about 45° C.

Controls 58 include preferably an on button, an off button, a red light emitting diode (hereinafter LED), and a green LED. The red LED is used to indicate that warmer 10 is provided with power, e.g., the warmer is plugged in. The red LED and green LED blink to indicate to the user that warmer 10 is warming up the fluid. When the fluid is ready for dispensing at the desired temperature, the red LED turns off and the green LED is on continuously. In the preferred embodiment, controls 58 are located at the top of upper lid 46 and under a membrane keypad (not shown) to ensure that enclosed assembly 49 remains sealed.

Controls 58 also preferably have a temperature control dial (not shown). The temperature control dial is connected to controller 57 to allow the user to vary the desired temperature of warming system 50 within the ranges provided above. In a preferred embodiment, the temperature control dial is a potentiometer.

Alternative positioning of controls 58, as well as methods of control indication, may also be utilized. Controls 58 can also include a red LED, an on/off button and a temperature switch (not shown). The red LED can blink to alert the user that warmer 10 is on, and remains on once the warmer is ready to use. The temperature switch can be a three-position rocker switch that is adapted to set the temperature of heater 54 at one of three positions, such as HI, MEDIUM or LOW.

Controller 57 controls heater 54 to warm the lotion to the desired temperature while minimizing the overshoot of the desired temperature. Preferably, controller 57 controls heater 54 via an analog circuit, a digital circuit or the like.

While the preferred embodiment describes a manual pump device, alternatively an electric device can be utilized. In an alternate embodiment shown in FIG. 6, lotion delivery system 20 has a typical hand operated pump 22′ for delivering lotion from lotion supply 20 to lotion warming system 50 and to the user via output section 60. Hand pump 22′ has a dispenser plunger 23, a spring return 24, one or more check valves 25 and a dip tube 26. In this embodiment, tubing 52, preferably aluminum, has a vertical or stacked coil configuration and the resistance heater is a wire heater 54′ wound about tubing 52.

Controller 57, heater 54′ and aluminum tube 52 are sealed from water within enclosed assembly 49. The sealing is achieved preferably by a silicone gasket material 49′. The assembly 49 is stationary as dispense plunger 23 is actuated to dispense lotion from warmer 10. Preferably, assembly 49 is adapted to be connected to container 42 by a connector 47. In a preferred embodiment, connector 47 is a quick connection that simply requires the user to rotate the container not more than 180 degrees with respect to assembly 49.

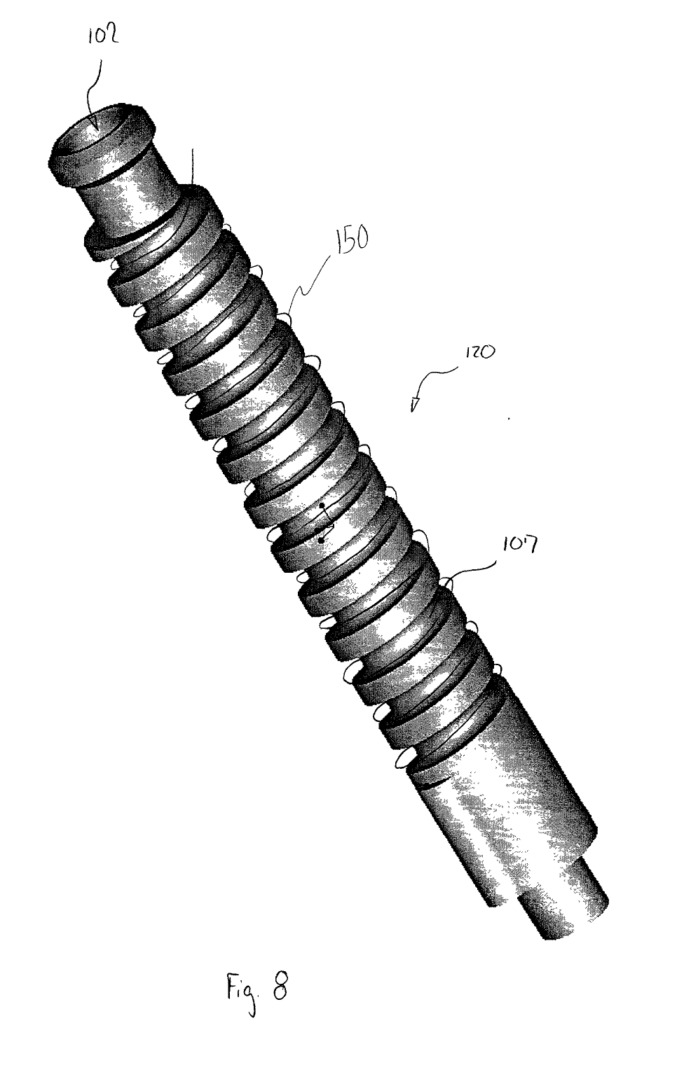

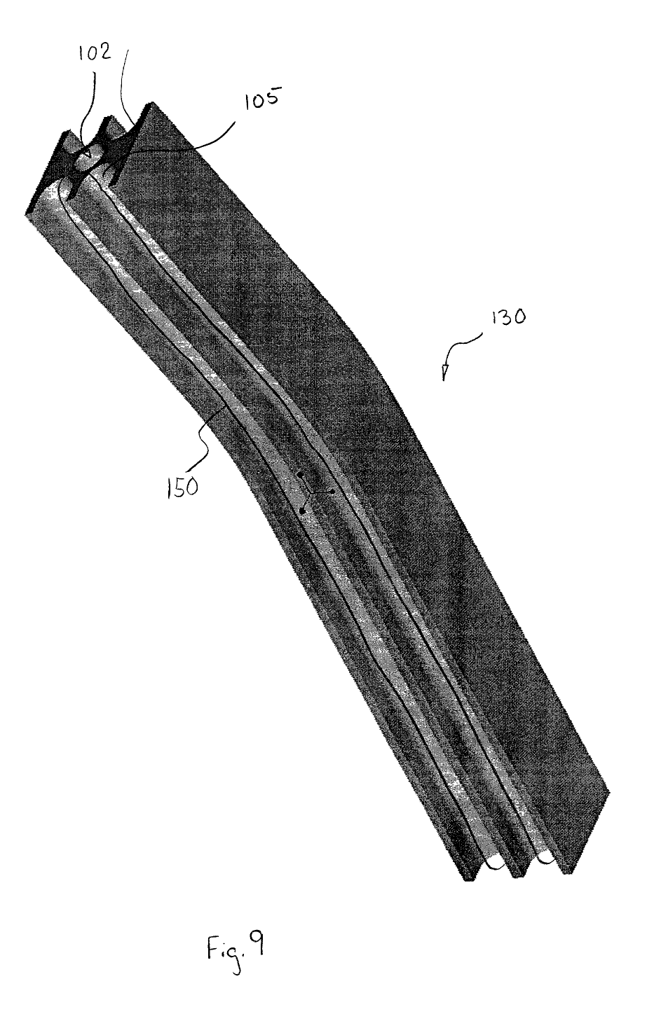

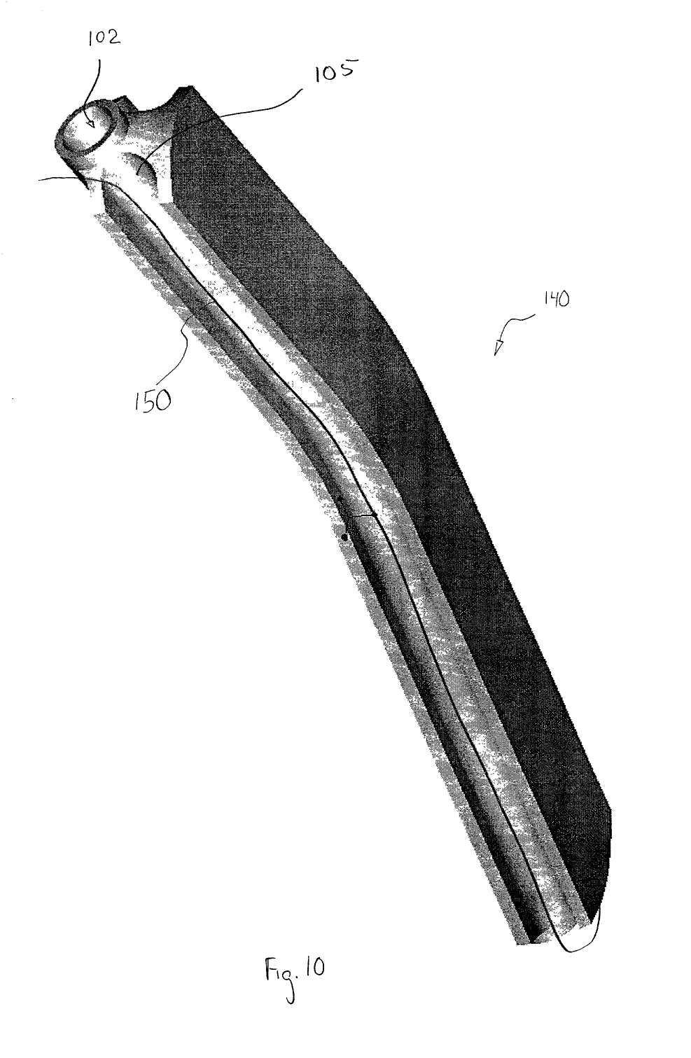

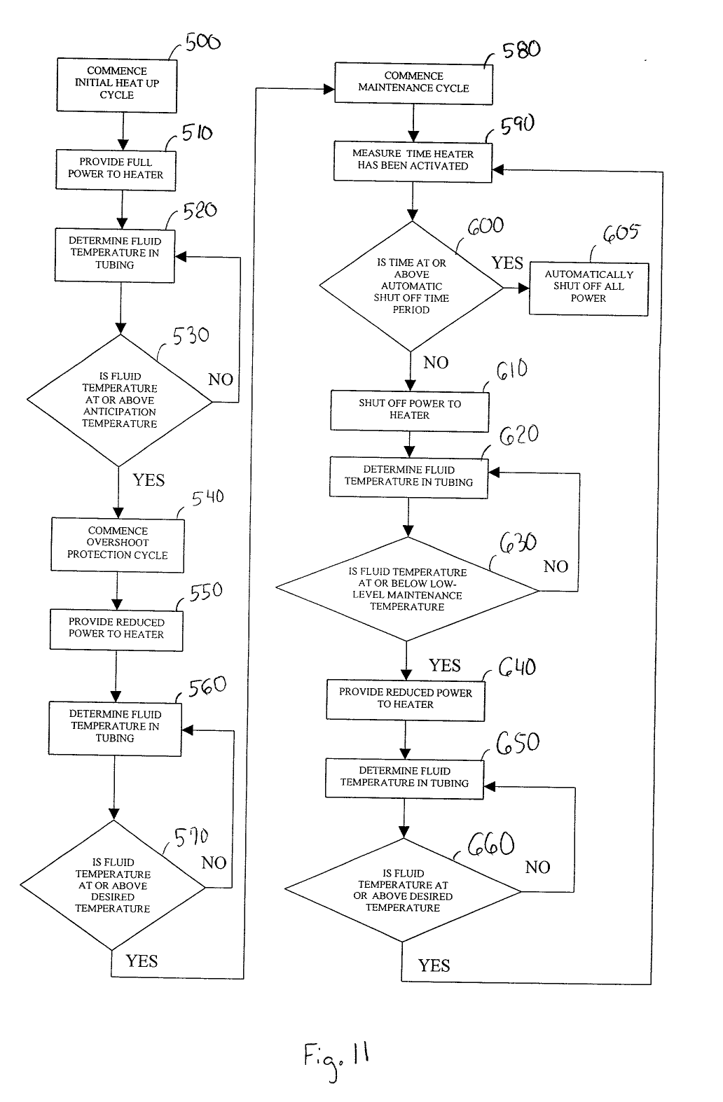

In alternative embodiments, heater 54 and tubing 52 can be replaced with a heat sink 100 and a heating wire 150 in contact with the heat sink. Referring to FIGS. 7 through 10, heat sink 100 is shown as cylindrical heat sinks 110, 120 and rectangular heat sinks 130, 140, respectively. However, other alternative shapes may also be utilized for heat sink 100 including cubical or triangular heat sinks. Heat sinks 110, 120, 130, 140 have an axial channel 102 in which the fluid is contained while being heated, and through which the fluid passes when being dispensed. Heat sinks 110, 130, 140 have channels 105 formed longitudinally therein. Channels 105 house heating wire 150, and maximize heat transfer surface area by partially surrounding the heating wire. Heat sink 120 has channels 107 formed circumferentially therein, preferably in a spiral manner, which also maximizes the heat transfer surface area by partially surrounding heating wire 150. These alternative embodiments that replace heater 54 and tubing 52 reduce the required volume for housing warming system 50 in warmer 10. Further, these alternative embodiments also have the advantage of allowing for heating of the entire warming system including output section 60, shown in FIG. 2. This causes faster heat up times and more efficient use of energy. Heat sink 100 is preferably made of aluminum. More preferably heat sink 100 is made of extruded aluminum.

In the embodiment shown, controller 57 controls heater 54 by using one of three cycles to heat the lotion in tubing 52. Namely, controller 57 includes an initial heat up cycle, an over shoot protection cycle and a maintenance cycle.

Referring to FIG. 11, controller 57 begins the initial heat up cycle when warmer 10 is turned “on”, as in step 500. During the initial heat up cycle, controller 57 provides full power to heater 54, as in step 510. The amount of power is about 5 watts to about 50 watts, preferably about twenty-seven watts. Controller 57 then determines the fluid temperature in tubing 52, as in step 520. Controller 57 then determines if the fluid temperature in tubing 52 is at or above the anticipation temperature, as in step 530. If the fluid temperature in tubing 52 is at or above the anticipation temperature then the overshoot protection cycle commences, as in step 540. The preset anticipation temperature preferably is between approximately 5° C. to approximately 15° C. less than the desired temperature.

During the overshoot protection cycle, controller 57 provides reduced power to heater 54, as in step 550. Preferably, the power to the heater is reduced by approximately fifty percent (or preferably to approximately thirteen and one half watts in the preferred embodiment). The power reduction slows the temperature increase as the temperature approaches the desired temperature and, thus, reduces the instance of heater 54 heating the lotion above the desired temperature.

Controller 57 then determines the fluid temperature in tubing 52, as in step 560. Controller 57 determines if the fluid temperature in tubing 52 is at or above the desired temperature, as in step 570. If the fluid temperature in tubing 52 is at or above the desired temperature then the maintenance cycle commences, as in step 580.

In step 590, the controller measures the length of time that the heater has been activated. Controller 57 then determines if the activation time is at or above the automatic shut off time period, as in step 600. If the activation time is at or above the automatic shut off time period then controller 57 shuts off all power, as in step 605.

In step 610, if the automatic shut off time period has not been met or exceeded, then controller 57 shuts off power to heater 54. Controller 57 determines the fluid temperature in tubing 52, as in step 620. The controller then determines if the fluid temperature in tubing 52 is at or below the low-level maintenance temperature, as in step 630. Preferably, the preset low-level maintenance temperature is between about 0.5° C. to about 10.0° C. less than the desired temperature. More preferably, the preset low-level maintenance temperature is between about 1.0° C. to about 1.5° C. less than the desired temperature. If the fluid temperature in tubing 52 is at or below the low-level maintenance temperature then controller 57 provides reduced power to heater 54, as in step 640. Preferably, the reduced power to heater 54 is approximately one-half, e.g., thirteen and one-half watts in the preferred embodiment. Accordingly, during the maintenance cycle, controller 57 maintains the temperature of heater 54 at a point approximately between the low-level maintenance temperature and the desired temperature.

Controller 57 continues to determine the fluid temperature in tubing 52, as in step 650. Controller 57 determines if the fluid temperature in tubing 52 is at or above the desired temperature, as in step 660. If the fluid temperature in tubing 52 is at or above the desired temperature then the controller repeats the steps of the maintenance cycle.

In use, the user activates pump 22 to deliver lotion from container 42 into tubing 52. Tubing 52 is preferably primed with lotion prior to activating heater 54 via control button 58. To active pump 22, the user simply depresses enclosed assembly 49 down with respect to container 42. To deactivate the pump, the user releases enclosed assembly 49, which returns to its up position. Preferably about three cubic centimeters (3 cc) of lotion heated to about the desired temperature is dispensed each time the user depresses enclosed assembly 49.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A fluid delivery system comprising:
a first reservoir having a first volume;
a second reservoir having a second volume and connected to said first reservoir;
a pump device operatively connected to said first reservoir and said second reservoir;
a heating device in thermal communication with said first reservoir and in substantial thermal isolation from said second reservoir; and
a delivery device connected to said first reservoir,
wherein said pump device selectively causes fluid to flow from said second reservoir to said first reservoir, from said first reservoir to said delivery device and from said delivery device to the atmosphere.

2. The fluid delivery system of claim 1, wherein said first volume is substantially smaller than said second volume.

3. The fluid delivery system of claim 1, wherein said delivery device comprises a downwardly directed spout.

4. The fluid delivery system of claim 2, wherein said fluid is dispensed at a temperature between about 30° C. to about 60° C.

5. The fluid delivery system of claim 2, wherein said first reservoir is a coiled tube.

6. The fluid delivery system of claim 2, wherein said pump device is manual.

7. The fluid delivery system of claim 2, wherein said pump device is electric.

8. The fluid delivery system of claim 2, further comprising an electrical component that controls said heating device, wherein said electrical component is in fluid isolation from said first reservoir and said second reservoir.

9. The fluid delivery system of claim 2, further comprising a thermostat that controls said heating device, wherein said thermostat is in fluid isolation from said first reservoir and said second reservoir.

10. The fluid delivery system of claim 5, wherein said coiled tube is flat.

11. The fluid delivery system of claim 5, wherein said coiled tube is made of aluminum.

12. The fluid delivery system of claim 8, wherein said electrical component is in substantial thermal isolation from said heating device and said first reservoir.

13. The fluid delivery system of claim 10, wherein said coiled tube is wound about five times.

14. The fluid delivery system of claim 12, wherein said electrical component has a manual power control switch.

15. The fluid delivery system of claim 12, wherein said electrical component has an automatic power shut off switch.

16. The fluid delivery system of claim 15, wherein said automatic shut off switch triggers after a period of time has elapsed.

17. A fluid delivery system comprising:
a first reservoir having a first volume;
a second reservoir having a second volume and connected to said first reservoir;
a pump device operatively connected to said first reservoir and said second reservoir;
a heating device in thermal communication with said first reservoir and in substantial thermal isolation from said second reservoir; and
a delivery device connected to said first reservoir;
wherein said pump device selectively causes fluid to flow from said second reservoir to said first reservoir, from said first reservoir to said delivery device and from said delivery device to the atmosphere; and said second reservoir is removable from said fluid delivery system.

18. The fluid delivery system of claim 17, wherein said first volume is substantially smaller than said second volume.

19. The fluid delivery system of claim 17, wherein said pump device is manual.

20. The fluid delivery system of claim 18, wherein said first reservoir is a coiled tube.

21. The fluid delivery system of claim 20, wherein said coiled tube is flat.

22. The fluid delivery system of claim 20, wherein said coiled tube is wound about five times.

23. The fluid delivery system of claim 20, wherein said coiled tube is made of aluminum.

24. The fluid delivery system of claim 23, wherein said delivery device comprises a downwardly directed spout.

25. The fluid delivery system of claim 18, further comprising a thermostat that controls said heating device, wherein said thermostat is in fluid isolation from said first reservoir and said second reservoir.

26. The fluid delivery system of claim 18, further comprising an electrical component that controls said heating device, wherein said electrical component is in fluid isolation from said first reservoir and said second reservoir.

27. The fluid delivery system of claim 26, wherein said electrical component is in substantial thermal isolation from said heating device and said first reservoir.

28. The fluid delivery system of claim 26, wherein said electrical component has a manual power control switch.

29. The fluid delivery system of claim 26, wherein said electrical component comprises an automatic power shut off switch.

30. The fluid delivery system of claim 29, wherein said automatic shut off switch triggers after a period of time has elapsed.

31. The fluid delivery system of claim 17, wherein said pump device is electric.

32. The fluid delivery system of claim 18, wherein said fluid is dispensed at a temperature between about 30° C. to about 60° C.

33. A fluid delivery system comprising:
a first reservoir having a first volume;
a second reservoir having a second volume and connected to said first reservoir;
a pump device operatively connected to said first reservoir and said second reservoir; and
a heating device in thermal communication with said first reservoir and in substantial thermal isolation from said second reservoir,
wherein said pump device selectively causes fluid to flow from said second reservoir to said first reservoir and from said first reservoir to the atmosphere; and said first reservoir comprises a heat sink.

34. The fluid delivery system of claim 33, wherein said first volume is substantially smaller than said second volume.

35. The fluid delivery system of claim 33, wherein said heat sink has a shape selected from the group consisting essentially of cubical, rectangular, triangular, and cylindrical shapes.

36. The fluid delivery system of claim 33, wherein said heating device comprises a heating wire in contact with said heat sink.

37. The fluid delivery system of claim 36, wherein said heat sink has channels formed therein for housing at least a portion of said heating wire.

38. The fluid delivery system of claim 33, wherein said heat sink is made of aluminum.

39. The fluid delivery system of claim 33, wherein said pump device is manual.

40. The fluid delivery system of claim 33, wherein said pump device is electric.

41. The fluid delivery system of claim 33, further comprising a thermostat that controls said heating device, wherein said thermostat is in fluid isolation from said first reservoir and said second reservoir.

42. The fluid delivery system of claim 33, further comprising an electrical component that controls said heating device, wherein said electrical component is in fluid isolation from said first reservoir and said second reservoir.

43. The fluid delivery system of claim 42, wherein said electrical component is in substantial thermal isolation from said heating device and said first reservoir.

44. The fluid delivery system of claim 43, wherein said electrical component has a manual power control switch.

45. The fluid delivery system of claim 43, wherein said electrical component has an automatic power shut off switch.

46. The fluid delivery system of claim 45, wherein said automatic shut off switch triggers after a period of time has elapsed.

47. The fluid delivery system of claim 33, wherein said second reservoir is removable from said fluid delivery system.

48. The fluid delivery system of claim 33, wherein said fluid is dispensed at a temperature between about 30° C. to about 60° C.

49. A fluid delivery system comprising:
a first reservoir having a first volume;
a second reservoir having a second volume and connected to said first reservoir;
a pump operatively connected to said first reservoir and said second reservoir;
a heating device in thermal communication with said first reservoir and in substantial thermal isolation from said second reservoir; and
a housing surrounding said first reservoir and said heating device, and forming a substantially water tight seal around said first reservoir and said heating device,
wherein said pump selectively causes a fluid to flow from said second reservoir to said first reservoir and from said first reservoir.

50. The fluid delivery system of claim 49, wherein said second reservoir is removable from the fluid delivery system.

51. The fluid delivery system of claim 49, wherein said first volume is substantially smaller than said second volume.

52. The fluid delivery system of claim 49, wherein said first reservoir comprises a heat sink.

53. The fluid delivery system of claim 52, wherein said heat sink has a shape selected from the group consisting essentially of cubical, rectangular, triangular, and cylindrical shapes.

54. The fluid delivery system of claim 52, wherein said heating device comprises a heating wire in contact with said heat sink.

55. The fluid delivery system of claim 54, wherein said heat sink has channels formed therein for housing at least a portion of said heating wire.

56. The fluid delivery system of claim 52, wherein said heat sink is made of aluminum.

57. The fluid delivery system of claim 49, wherein said pump is manual.

58. The fluid delivery system of claim 49, wherein said pump is electric.

59. The fluid delivery system of claim 49, further comprising a thermostat that controls said heating device, wherein said thermostat is in fluid isolation from said first reservoir and said second reservoir.

60. The fluid delivery system of claim 49, further comprising an electrical component that controls said heating device, wherein said electrical component is in fluid isolation from said first reservoir and said second reservoir.

61. The fluid delivery system of claim 60, wherein said electrical component is in substantial thermal isolation from said heating device and said first reservoir.

62. The fluid delivery system of claim 60, wherein said electrical component has a manual power control switch.

63. The fluid delivery system of claim 60, wherein said electrical component has an automatic power shut off switch.

64. The fluid delivery system of claim 63, wherein said automatic shut off switch triggers after a period of time has elapsed.

65. The fluid delivery system of claim 49, wherein said fluid exits said first reservoir at a temperature between about 30° C. to about 60° C.

66. A method of heating fluid in a fluid delivery system having a first reservoir, a second reservoir, and a heating device, said first reservoir being in thermal communication with said heating device and said second reservoir being in substantial thermal isolation from said heating device, comprising the steps of:
commencing a heat up cycle by:
providing full power to the heating device;
determining the fluid temperature in the first reservoir; and
determining if said fluid temperature is at or above a first temperature;
commencing an overshoot protection cycle when said fluid temperature is at or above said first temperature by:
providing reduced power to said heating device;
determining said fluid temperature in said first reservoir; and
determining if said fluid temperature is at or above a second temperature; and
commencing a maintenance cycle when said fluid temperature is at or above said second temperature by:
shutting off power to said heating device;
determining said fluid temperature in said first reservoir;
determining if said fluid temperature is at or below a third temperature;
providing reduced power to said heating device when said fluid temperature is at or below said third temperature;
determining said fluid temperature in said first reservoir;
determining if said fluid temperature is at or above said second temperature; and
repeating said maintenance cycle steps when said fluid temperature is at or above said second temperature.

67. The method of claim 66, further comprising the steps of:
measuring the time said heating device has been activated after said maintenance cycle has commenced;
determining if said time is at or above a time limit; and
automatically shutting off said power when said time is at or above said time limit.

68. The method of claim 66, wherein said first temperature is pre-determined.

69. The method of claim 66, wherein said first temperature is about 5° C. to about 15° C. less than said second temperature.

70. The method of claim 66, wherein said third temperature is pre-determined.

71. The method of claim 66, wherein said third temperature is about 0.5° C. to about 10.0° C. less than said second temperature.

72. The method of claim 66, wherein said reduced power is about half of said full power.

73. The method of claim 67, wherein said time limit is predetermined.

74. The method of claim 67, wherein said time limit is about one hour.
